(19) United States
(12) Patent Application Publication
(10) Pub. No.: US 2022/0403098 A1
(43) Pub. Date: Dec. 22, 2022

(54) PHENALKAMINE EPOXY CURING AGENT FOR OUTDOOR TOP COAT APPLICATION

(71) Applicants: DATTATRAYA PANDURANG BARDE, MUMBAI (IN); RAKESH NAMA PATIL, PANVEL (IN)

(72) Inventors: DATTATRAYA PANDURANG BARDE, MUMBAI (IN); RAKESH NAMA PATIL, PANVEL (IN)

(21) Appl. No.: 15/733,684

(22) PCT Filed: Sep. 27, 2020
(86) PCT No.: PCT/IB2020/059030

§ 371 Date: Sep. 29, 2020

(30) Foreign Application Priority Data
Feb. 27, 2020 (IN) 202021008277

(51) Int. Cl. C08G 59/18; C09D 163/00

(52) U.S. Cl. CPC C08G 59/184; C09D 163/00

(57) ABSTRACT

Phenalkamine epoxy curing agent for outdoor top coat application A novel Mannich reaction based phenalkamine for outdoor application which includes a) para substituted phenol reaction product with polyamine and aldehyde, b) adduct with epoxy resin containing two glycidyl groups. Phenalkamine produced is diluted with an inert solvent. The top coat shows good ultra violet radiation stability, low colour, colour and gloss retention, low viscosity with excellent corrosion resistance. The two-pack epoxy resin paint composition based on Phenalkamine curing agent for outdoor application has very good adhesion as undercoat and very good over coating performance as top coat.

### FIELD OF INVENTION

This invention relates to the field of epoxy curing agent, it is more particularly related to the field of para substitute phenol based phenalkamine curing agent modified to produce ultra-violet radiation stable epoxy curing agent for outdoor top coat application.

### PRIOR WORKS OF ART

None of the prior works reported in the field closely resembles the work of the present invention. The reported works relate to systems employing a hardner for liquid epoxy resins or modified epoxy resins. Some of these works are as follows:

WO 2019097039 AI: This prior work relates to top coat composition, comprising Michael addition reaction components and a catalyst. It substantially differs from and is dissimilar to the work of the present invention.

U.S. Pat. No. 6,045,873A: This prior work relates to a one-pack epoxy resin composition that has several ingredients such as a ketimine compound, a dehydrating agent, an epoxy resin having an average molecular weight of 250 to 4000, a urethane-modified epoxy resin or an amine-modified or a dimer acid modified epoxy resin or an epoxy resin adduct with a dimer acid. The work of the present invention has none of the said ingredients and it is therefore, substantially dissimilar to the said prior works.

KR 20100093664 (A): This cited work relates to epoxy resin hardner to secure room temperature drying property, Low temperature drying property and corrosion resistance of the hardner to improve flexibility and elasticity. The hardner is obtained by reacting an ethoxylate or propoxylate bisphenol-A based epoxy resin with weight average molecular weight of 100-2000 with a resin selected from the group consisting of a diamine resin, a polyamide resin or a phenalkamine resin.

US 2010012888 (AI): The cited work relates to a mixture of crosslinking agents as epoxy resin hardner, employing a four-step reaction and comprising at least one polyamide functional compound and at least one phenalkamine functional compound. The four-step reaction employs (a) a mixture of a cardanol and a cardol; (b) high temperature high pressure synthesis of dibasic fatty acid methyl ester; (c) a mixture of triethylene tetramine and tetraethylene pentamine.

### OBJECTIVES OF THE PRESENT INVENTION

The present invention uses nonyl phenol as the alkyl phenol, a mixture of diethylene triamine and isophoronediamine in a two-step synthesis of epoxy adduct, followed by in third step dilution with benzyl alcohol. The present invention substantially is different than the cited work. The present invention substantially is different than the cited work in terms of the reactants employed and the overall method for the synthesis of phenalkamine epoxy curing agent. The present invention makes no use of bisphenol-A based epoxy resin.

One objective of the present invention is to provide an ultra violet-stable phenalkamine epoxy curing agent, suitable for top coat application in anti-corrosive industrial and marine applications.

Another objective of the present invention is to provide a paint composition based on ultra violet stable phenalkamine epoxy curing agent, for top coat application when cured with liquid epoxy resin.

### SUMMARY OF THE INVENTION

The present invention relates to a para-substituted phenol based, ultra violet radiation-stable phenalkamine curing agent for liquid epoxy resins comprising: i) reaction product of a para-substituted phenol, polyamine and paraformaldehyde via Mannich base reaction; ii) further modification with a liquid epoxy resin having at least two glycidyl groups in the molecule into an epoxy adduct; and iii) dilution of the modified mass with an inert solvent.

### DETAILED DESCRIPTION

Epoxy resin compositions provide excellent protective and decorative coatings for metal and many other substrates. Two-part epoxy systems are so called because they comprise two components, an epoxy resin and a curing agent. The two components must be stored separately and are combined shortly before use. The phenalkamine curing agents are traditionally used with epoxy resin due to its unique performance properties and low cost attributed to cardanol backbone in structure. However, use of cardanol based phenalkamine curing agents are restricted to undercoat due to their dark color and oxidation on outdoor exposure i.e. poor stability due to exposure to ultraviolet radiation.

Commercially cycloaliphatic amine adducts are used for ultra violet radiation stable top coat application which are expensive and increase cost of formulation. The application of phenalkamine curing agents can be extended in cost effective top coat if colour and ultraviolet radiation stability of composition is improved.

The novel Mannich base epoxy curing agents of the present invention can be prepared by reacting a phenolic compound containing at least one reactive position on aromatic ring with an aldehyde compound and at least one selected alicyclic polyamine, aliphatic polyamine or mixtures thereof.

Conventional phenalkamine curing agents are produced by reaction of distilled Cashew nut-shell liquid i. e. cardanol with polyamines and formaldehyde. Phenalkamine are based on renewable raw material i. e. cardanol with very good corrosion resistance, low viscosity, good adhesion, and fast curing at low temperature. With all these advantages, main drawback of these curing agents is dark colour and low colour retention when exposed to atmosphere.

Change in colour is mainly attributed to oxidation of cardanol which is a phenolic compound to phenoxy quinoidal products that are highly coloured. Phenoxy compound absorbs light in visible region and appears dark in colour. Phenoxy compounds formed are able to abstract hydrogen from other polymer chain and initiate new oxidation cycle. The distilled cashew nut shell liquid contains cardol with difunctional phenol which shows much deeper darkening of colour in phenalkamine cured epoxy systems. Due to dark colour and poor colour retention, distilled cashew nut shell liquid based phenalkamines are not meant for use in top coat application which are exposed to atmosphere.

Conventionally for top coat application, cycloaliphatic amine adduct, 2-pack aliphatic polyurethane systems based on alkyd and acrylic polymers are used in market. When compared in cost, these systems are more expensive than phenalkamine system. The invention descried in this work can be low price alternative for top coat applications. Substituted phenolic compounds are more stable to oxidation and colour change due to stabilizing effect of substitution on aromatic ring. Substitution of ortho and para position of phenolic compound can reduce the reactivity of hydroxyl function to oxidation. Furthermore, they stabilize phenoxy radical from further chain initiation.

The mole ratio of polyamine to phenolic compound is within the range of about 1:1 to about 10:1, more preferably from about 1:1 to about 2:1. Mole ratio of the polyamine to aldehyde compound is within the range of about 1:1 to about 4:1, preferably about 1:1 to about 2:1.

On an equivalent basis, ratio of aldehyde and amine should be more than or equal to one mole of amine per equivalent of the phenolic compound. Chemical reaction during synthesis is believed to involve electrophilic addition of the aldehyde to the phenolic compound to form an alkanolated phenol intermediate. Further condensation with the amine and elimination of water yields the Mannich base reaction product. The mole ratio of polyamine to phenolic compound is within the range of about 1:1 to about 10:1, more preferably from about 1:1 to about 2:1. Mole ratio of the polyamine to aldehyde compound is within the range of about 1:1 to about 4:1, preferably about 1:1 to about 2:1. On an equivalents basis, ratio of aldehyde and amine should be more than or equal to one mole of amine per equivalent of the phenolic compound. Chemical reaction during synthesis is believed to involve electrophilic addition of the aldehyde to the phenolic compound to form an alkanolated phenol intermediate. Further condensation with the amine and elimination of water yields the Mannich base reaction product.

The phenolic compounds used are from class of para substituted phenols. [symbol] , 4,4-(hexafluoroisopropylidene)diphenol, 4,4-thiodiphenol, 4,4→dihydroxybenzophenone, i-cresol, Nonyl phenol, Bisphenol A, Bisphenol F, para tertiary butyl phenol (PTBP), para phenyl phenol, mixture thereof and alike.

In preparation of phenalkamine curing agent formaldehyde is used for condensation. Other aldehyde which can be used are acetaldehyde, furfuraldehyde and alike.

The polyamine used for producing phenalkamine are selected from aliphatic, aromatic or alicyclic polyamine and mixture thereof. The Polyamine is preferably ethylene diamine (EDA), diethylene triamine (DETA), triethylenetetramine (TETA), Xylenediamine, 1,3-bis(aminomethyl)cyclohexane, Isophorondiamime (IPD), n-aminoethylpiperazine, menthanediamine and mixtures thereof can be used for synthesis. Preferably alicyclic polyamine can be used in combination with other aliphatic polyamines. The aminoalkyl group is preferably an aminomethyl, aminoethyl, aminopropyl or aminobutyl, wherein the alkyl group is either a straight chain or branched. More preferably, the aminoalkyl group is aminomethyl or aminoethyl.

The phenalkamine produce by Mannich reaction of substituted phenolic compound with polyamine and formaldehyde are reacted with epoxy resin to produce adduct which enhance their performance properties. Adduct was produced with epoxy resin with at least two glycidyl ether groups. Resin backbone may be saturated or unsaturated, aliphatic, cycloaliphatic, aromatic, or heterocyclic and may be substituted, having at least one substituent such as halogen or hydroxyl. Epoxy resin—monomeric or polymeric—with equivalent epoxy weight (EEW) from 150 to 3000 include bisphenol A diglycidyl ether, bisphenol F diglycidyl ether, resorcinol diglycidyl ether, triglycidyl of trimethalol propane and alike.

The final phenalkamine is produced by dilution with solvent like phenoxy ethanol, benzyl alcohol, Nonyl phenol, 2 hydroxyl ethyl ether of distilled CNSL, dodecanol and higher analogs, mixture and alike. Dilution was advisable to reduce viscosity and easy workability with improvement in cured film properties.

### TEST METHODS

The paint compositions prepared are tested for drying, corrosion resistance, UV resistance, adhesion, overcoat ability and over coating performance.

Test Method

A metal plate measuring 0.8×100×150 mm is Sand by 400 emery paper and after that brush coated with the 2K epoxy coating composition to a dry film thickness of about 200 [symbol] m, and the coating is dried at 25éC and 65% RH for 7 days giving a test specimen.

Unless indicated otherwise, the following test methods were utilized in the Examples that follow.

1. Amine Value

Amine value of phenalkamine produced was tested according to ASTM D 2074. The indictor titration method was used and value of test are mentioned as mg/KOH.

2. Viscosity

Viscosity is measured according to ASTM D 2196 with Brookfield digital viscometer LVDV model having multiple rotational speed. When not mentioned parameters are spindle number 63, rotation speed 30 RPM and temperature 25 éC for testing.

3. Color

Gardner scale color of product is mentioned following ASTM D1544. Color of the test specimen was compared with standard Gardner scale and close match is mentioned.

4. Drying Performance

Phenalkamine produced are cross linked with liquid epoxy resin EEW 190 to test performance properties of cured film. ASTM D 5895 was followed to record test results. Drying performance are tested at 25 éC and 5 éC with 200 [symbol] m D FT on B. K . Drying recorder.

5. Adhesion Test: Adhesion testing was performed to assess whether the coating compositions adhere to the coated substrate. The Adhesion Test was performed according to ASTM D 3359—Test method.

The results are rated as follows:

A: No abnormalities,

B: Peelings on part of the top coating surface,

C: Peelings on the entire top coating surface

6. Corrosion Resistance

Panel Preparation: Two Mild steel panels of size 100×150 mm which is sand by 400 no. emery paper were taken for paint application, Apply Paint by brush application, DFT of the applied coating is 100 [symbol] m. After 7 days of ageing sealed the edges with Adhesive tape and Expose for the testing.

The corrosion resistance was check with standard method ASTM B117. The test panel were prepared and subjected to salt spray conditions and evaluated for rusting and blisters. The condition of the coating Surface was rated as follows:

A: No abnormalities,

B: Partially rusted or blistered,

C: Entirely rusted or blistered

7. Exterior Exposure Test.

Exterior exposure test was performed according to ASTM D-1014-02. Two Mild steel panels of size 100×150 mm which is sand by 400 no. polish paper were taken for paint application, apply 2K Epoxy White Paint composition with UV stable Phenalkamine curing agent. After 7 days of curing sealed the edges with Adhesive tape and use for outdoor exposure testing. Similarly, prepared control sample for comparatives study. Expose the panel at the angle of 45é facing to south equator for 12 months. Exposed panels were tested after each 2 months visually for Rusting, Checking, Cracking, Blistering, flaking also for gloss retention against controlled sample and Test reports are mention as average of duplicate samples.

Surface was rated as follows for visual inspection.

A: No abnormalities,

B: Slightly Yellowing, No Rusting, Checking, Cracking, Blistering.

C: Yellowing Partially Rusting, Checking, Cracking, Blistering or Flaking.

D: Total Shade change, Entirely Rusting, Checking, Cracking, Blistering or Flaking.

The results of this test for coatings prepared according to the present invention are presented in Tables 3.

The paint composition based on the phenalkamine of the present invention may further include any of various paint additives, such as pigment, extender pigment, anticorrosive pigment, thickening agent, plasticizer, filler, solvents, dryers, dispersant or alike. The phenalkamine curing agent and paint composition described in this invention are used for top coat application on substrates such as mild steel, stainless steel, galvanized steel, aluminium, wood and concrete.

### EXAMPLE 1

### Synthesis of Para Substituted Phenol Based Mannich Base

A phenalkamine is produced by reaction of Nonyl phenol with alicyclic amine and formaldehyde. In particular, 50 grams of Nonyl phenol, 26 gram DETA and 22 grams of IPD are charged in four-necked round bottom flask equipped with a condenser, thermometer, a mechanical stirrer, and a nitrogen connection to form a reaction mixture. Then, the flask is thoroughly purged and protected with nitrogen, agitation of the reaction mixture within the flask is started and heat is applied to the reaction mixture. Once a temperature of 70éC is reached, 15 grams of paraformaldehyde was added in reaction mixture. Exotherm is control by cooling reaction mixture and temperature is maintained between 70 to 80 éC for 3-4 hr. After that, water of condensation was removed by raising temperature of reaction mixture to 130 éC. The product obtained with color 2, amine value 520 mg/KOH, and viscosity @ 25éC was 4500 cps.

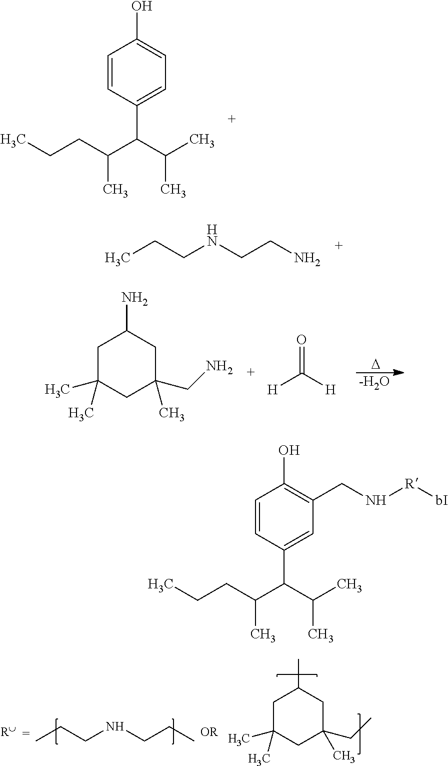

The product obtained in example 1 is reacted with liquid epoxy resin EEW 190 to form adduct before further modification. In particular, 60 grams of product from Example 1 is charged in four-necked round bottom flask equipped with a condenser, thermometer, a mechanical stirrer, and a nitrogen connection to form a reaction mixture for producing phenalkamine. Under agitation heat is applied to the reaction mixture. Once a temperature of 70-80éC is reached, add 10 gram of liquid epoxy resin with EEW 190 over period of 1 hr. After addition maintain temperature for 2-3 hr, nitrogen protection is continued until the formation of phenalkamine. The reaction mixture is cooled to 40éC and final phenalkamine is produce by addition of 35 grams of benzyl alcohol. The phenalkamine was produce with color 1-2, amine value 290 mg/KOH, and viscosity @ 25éC was 500 cps.

### EXAMPLE 2

### Synthesis of UV Stable Phenalkamine Curing Agent

The product obtained in example 1 is reacted with liquid epoxy resin EEW 190 to form adduct before further modification. In particular, 60 grams of product from Example 1 is charged in four-necked round bottom flask equipped with a condenser, thermometer, a mechanical stirrer, and a nitrogen connection to form a reaction mixture for producing phenalkamine. Under agitation heat is applied to the reaction mixture. Once a temperature of 70-80éC is reached, add 10 gram of liquid epoxy resin with EEW 190 over period of 1 hr. After addition maintain temperature for 2-3 hr, nitrogen protection is continued until the formation of phenalkamine. The reaction mixture is cooled to 40éC and final phenalkamine is produce by addition of 35 grams of benzyl alcohol. The phenalkamine was produce with color 1-2, amine value 290 mg/KOH, and viscosity @ 25éC was 500 cps.

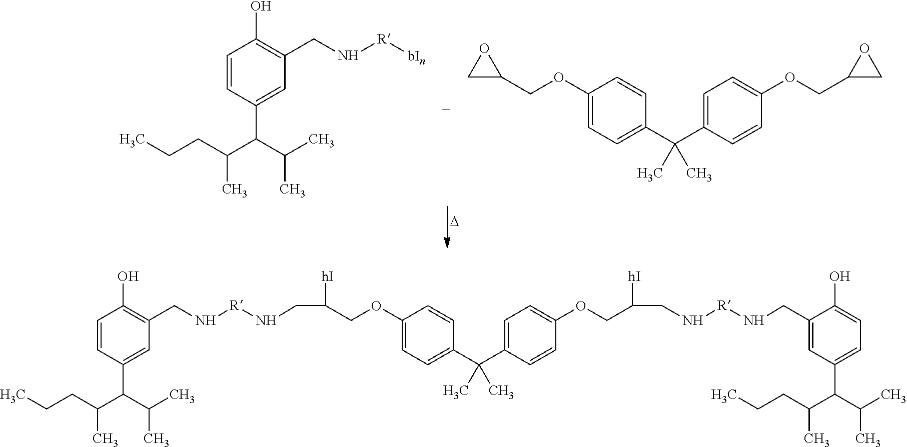

### EXAMPLE 3

### 2K Epoxy Resin Paint Composition with UV Stable Phenalkamine curing agent

All of the Base ingredients were combined in the high-speed dissolver. The ingredients of Part A were combined according to the order reflected in Table 1. Once all of the ingredients were combined, the ingredients were Mix in a high-speed dissolver until a smooth finish on panel was achieved. Once this smooth finish was achieved, the temperature of the blend was brought to approximately 120 éF (approximately 48.9éC) and held for approximately 20 minutes while the ingredients were continuously agitated.

Part B is UV stable phenalkamine curing agent from example 2 reflected in Table 1, was kept separate.

At the time of coating application Mix. the Base & Hardener part as per weight ratio Base Part-82 gms. and Hardener Part 18 gms.

TABLE 1
Coating Paint Compositions.

| Description | Example-3 |
|---|---|
| Part ⁻A (Epoxy Base) | |
| ¹Epoxy Resin (Ep-Eq.-190) | 36.00 |
| ²Disperlon DA-325 | 0.300 |
| ³Titanium Di-oxide | 16.00 |
| ⁴Barytes (20 micron) | 12.60 |
| ⁵Silica (20 micron) | 16.00 |
| ⁶Disperlon A-630-20X | 1.00 |
| ⁷Disperlon SPX-21 | 0.100 |
| Part-B (Hardener) | |
| Example 2 Curing agent | 18.00 |

### EXAMPLE 4 & 5

### Paint Composition of Epoxy and Polyurethane (Two Pack) for Over Coating

Phenalkamine synthesized in example 2 is tested for undercoat coating performance over which top coat 2-pack epoxy and 2-pack polyurethane paint compositions are applied after 24 hours curing.

All of the ingredients are combined in the sand mill. In Examples, the ingredients of Part A are combined according to the order reflected in Table 2. Once all of the ingredients are combined, the ingredients are ground in sand mill until a Hegman reading greater than 7.0.0.

[symbol] is achieved. The temperature of the blend then is brought to approximately 120 F (approximately 48.9 éC) and is held for approximately 20 minutes while the ingredients are continuously agitated. Next, Part B is prepared by combining the ingredients under agitation in the order reflected in Table 2. Part B is added slowly to grinding machine for flushing. After flushing, the flushed material is added into Part A under agitation. Part C is prepared by combining the ingredients under agitation in the order reflected in Table 2. Part C is added slowly to Part A under agitation.

Part D is then prepared by combining the ingredients reflected in Table 2 under agitation. Then, Part D is added under agitation at the time of application to the already combined blend of Parts A, B and C.

### EXAMPLE 6

### Ultra Violet-Stable Top Coat Application Over 2-Pack Epoxy Primer Based on Cardanol Phenalkamine Curing Agent

Phenalkamine synthesized in example number 2 is tested as top coat over coating performance on 2-pack epoxy paint composition with commercially available cardanol based phenalkamine curing agent PPA-7558 after 24 hours curing.

All of the base ingredients are combined in the high-speed dissolver. The ingredients of Part A are combined according to the order reflected in Table 2. Once all of the ingredients are combined, the ingredients are mixed in a high-speed dissolver until a smooth finish on panel is achieved. Once this smooth finish is achieved, the temperature of the blend is brought to approximately 120 éF (approximately 48.9éC) and held for approximately 20 minutes while the ingredients are continuously agitated.

Part B is then prepared and is kept separate.

At the time of coating application, mix the base and hardener parts as per weight ratio. Base Part-87 grams, and hardener Part 13 grams.

TABLE 2
Coating Compositions

| Description | Example 4 | Example 5 | Example 6 |
|---|---|---|---|
| Part ⁻A | | | |
| ¹Epoxy Resin (Ep-Eq.-190) | | | 25.00 |
| ⁹Epoxy Resin (Ep-Eq.-480) | 12.00 | — | |
| ¹⁰Acrylic Polyol (OH-Value 50) | — | 12.00 | |
| ¹⁵Pepox-7513 | | | 5.400 |
| ¹¹Urea Formaldehyde Resin | 1.00 | — | |
| Nuosper-657 | 0.30 | 0.30 | 0.500 |
| Ethyl Cello solve Acetate | — | 1.5 | |
| Xylene | 8.00 | 8.00 | |
| Butanol | 1.5 | — | |
| MIBK | 1.5 | — | |
| Titanium Di-oxide | 16.00 | 19.00 | 6.00 |
| ¹²Bent one Jelly 10% in Xylene. | 7.00 | 2.00 | |
| ⁵Silica (20 micron) | | | 17.00 |
| ⁴Barytes (20 micron) | | | 18.00 |
| ¹⁶Steatite (20 micron) | | | 5.20 |
| ¹⁷Marble Powder (20 micron) | | | 5.50 |
| ⁶Disperlon A-630-20X | | | 1.00 |
| ⁷Disperlon SPX-21 | | | 0.100 |
| Xylene | | | 2.30 |
| Butanol | | | 1.00 |
| Part-B | | | |
| Xylene | 4.00 | 1.5 | |
| Butanol | 1.50 | — | |
| Ethyl Cello solve Acetate | — | 1.5 | |
| Part-C | | | |
| Epoxy Resin (Ep-Eq.-480) | 33.84 | — | — |
| Xylene | 4.02 | — | — |
| MIBK | 1.50 | — | — |
| Acrylic Polyol (OH-Value 50) | — | 43.00 | |
| Ethyl Cello solve Acetate | — | 1.20 | |
| Part-D | | | |
| ¹³Polyamide-125 | 7.84 | — | — |
| ¹⁴Aliphatic Isocyanate | — | 7.84 | |
| ¹⁸PPA-7558 | | | 13.00 |
| Butyl Acetate | — | 2.16 | |

The results of this test for coatings prepared according to the present invention are presented in Tables 3.

TABLE 3
Physical & Chemical properties paint composition

| Physical properties | | Results |
|---|---|---|
| B. K. Drying Time AT 25 éC. (RH65%) | | |
| Touch Dry | | 2 Hrs. |
| Hard Dry | | 8 Hrs. |
| B. K. Drying Time AT 5 éC. (RH 65%) | | |
| Touch Dry | | 7 Hrs. |
| Hard Dry | | 14 Hrs. |
| Solid content at 120 éC./1 hr. | | 98.50% |
| Density as per ASTM D-1475-98 | | 1.215\check{e}0.04 |
| Pot Life @ 25 éC. (100 gm.) | | 30 Min |
| Performance properties | | |
| Salt Spray Resistance as per ASTM-B-117 at | | A |
| 100 ι m DFT on Mild Steel surface, after | | |
| 1000 Hrs. | | |
| Adhesion On, | | |
| Mild steel | | A |
| Stainless steel | | A |
| Galvanized steel | | A |
| Aluminum | | A |
| Concreate | | A |
| Wood | | A |
| As a primer Over Coating Adhesion | | |
| Performance @ 100 ι m DFT (After 24 hr) | | |
| With I).2K Epoxy systems @ 40 ι m | | A |
| With II).2K PU systems @ 40 ι m | | A |
| As a Top Coat Over Coating Adhesion | | |
| Performance @ 100 ι m DFT(After 24 hr.) | | |
| With I).2K Epoxy systems @ 100 ι m | | A |
| | Visual | Gloss |
| Exterior Exposure Test | inspection | Retention |
| After 2 Months | A | 90% |
| After 4 Months | A | 85% |
| After 6 Months | A | 75% |
| After 8 Months | B | 70% |
| After 10 Months | B | 70% |
| After 12 Months | B | 70% |

### BEST METHOD OF OPERATING THE INVENTION

1. Best method for the manufacture of novel ultra violet radiation-stable phenalkamine epoxy curing agent is described in examples 1 and 2.

2. Best method for the manufacture of ultra violet radiation-stable phenalkamine coating composition is described in example 3 and such coating composition is determined to be excellent in workability, has excellent ultra violet radiation stability, shelf-life stability, drying characteristics, corrosion resistance, and adhesion to mild steel, stainless steel, galvanized steel, aluminium, wood and concrete.

We claim:

1. A para substituted phenol based, ultraviolet radiation-stable phenalkamine curing agent comprising:
i) reaction product of para substituted phenol, polyamine and paraformaldehyde via Mannich base reaction;
ii) further modification with a liquid epoxy resin having at least two glycidyl groups in the molecule to form an epoxy adduct; and
iii) dilution of the modified mass with an inert solvent.

2. A para substituted phenol based, ultra violet radiation-stable phenalkamine as claimed in claim 1, wherein the said para substituted phenol is a Hydroquinone, 4,4′-(hexafluoroisopropylidene)diphenol, 4,4′-thiodiphenol, 4,4′-dihydroxybenzophenone, p.cresol, bisphenol A, bisphenol F, para tertiary butyl phenol (PTBP), para phenyl phenol, mixture thereof and more preferably nonyl phenol.

3. A para substituted phenol based, ultra violet radiation-stable phenalkamine as claimed in claim 1, wherein the said polyamine is ethylene diamine (EDA), diethylene triamine (DETA), triethylenetetramine (TETA), xylenediamine, 1,3-bis(aminomethyl)cyclohexane, isophorondiamime (IPD), n-aminoethylpiperazine, menthanediamine and mixtures thereof, and more preferably alicyclic polyamine-isophoronediamine—in combination with aliphatic polyamines-diethylene triamine.

4. A para substituted phenol based, ultra violet radiation-stable phenalkamine as claimed in claims 1 and 3, wherein aminoalkyl group is aminopropyl, aminobutyl, and more preferably aminomethyl or aminoethyl and the alkyl group is either a straight chain or branched.

5. A para substituted phenol based, ultra violet radiation-stable phenalkamine as claimed in claim 1, wherein the said epoxy resin has more than 1 to 2 epoxy groups per molecule or has at least two epoxide moieties per molecule and has epoxy equivalent weight from 150 to 3000.

6. A para substituted phenol based, ultra violet radiation-stable phenalkamine as claimed in claim 1, wherein the said Mannich base reaction is carried out at reaction temperature between 70 éC to 130 éC such that the phenalkamine produced has colour 2, amine value 520 mg/KOH and viscosity @ 25éC 4500 cps.

7. A para substituted phenol based, ultra violet radiation-stable phenalkamine as claimed in claim 1, wherein viscosity of the said phenalkamine product is reduced with inert solvents—phenoxy ethanol, nonyl phenol, 2 hydroxyl ethyl ether of distilled cashew nut shell liquid, dodecanol and higher analogues, mixture and preferably benzyl alcohol such that the said phenalkamine product has colour 1 -2, amine value 290 mg/KOH and viscosity @ 25éC 500 cps.

8. A para substituted phenol based, ultra violet radiation-stable phenalkamine as claimed in claim 1, wherein the molar ratio of the said polyamine to the said phenolic compound is between 1:1 and 10:1, and preferably is between 1:1 and about 2:1.

9. A para substituted phenol based, ultra violet radiation-stable phenalkamine as claimed in claim 1, wherein the molar ratio of the said polyamine to the said aldehyde is between 1:1 and about 4:1, and preferably between 1:1 and about 2:1.

10. The process to produce para substituted phenol based, ultra violet radiation-stable phenalkamine curing agent comprising steps of:
i) charging 50 grams nonyl phenol, 26 grams diethylene triamine (DETA) and 22 grams isophoronediamine into a four-necked round bottom flask equipped with a condenser, thermometer, a mechanical stirrer, and a nitrogen connection to form a reaction mixture;
ii) thoroughly purging the said flask and protecting the said contents in 8(i) with nitrogen, agitating the said reaction mixture within the flask and applying heat to the said reaction mixture;
iii) on the said reaction mixture reaching 70éC temperature, adding 15 grams paraformaldehyde to the said heated reaction mixture;
iv) controlling reaction exotherm by cooling the said reaction mixture and maintaining temperature between 70 to 80 éC for 3 to 4 hours;
v) removing the water of condensation by raising temperature of the said reaction mixture in 8(iv) to 130 éC until the product obtained has colour 2, amine value 520 mg/KOH and viscosity @ 25éC 4500 cps;
vi) charging 60 grams of the said reaction product in 8(v) into another four-necked round bottom flask equipped with a condenser, thermometer, a mechanical stirrer, and a nitrogen connection, agitating and applying heat to the said reaction mixture;
vii) on the said reaction mixture in 8(vi) reaching a temperature of 70-80éC, adding 10 gram of liquid epoxy resin with EEW 190 over period of 1 hour and maintaining the said temperature for 2-3 hours with nitrogen protection continuing until the formation of phenalkamine;
viii) cooling the said reaction product mixture to 40 éC and producing final phenalkamine by addition 35 grams benzyl alcohol such that the said phenalkamine has colour 1-2, amine value 290 mg/KOH and viscosity @ 25éC 500 cps; and
ix) diluting with the said inert solvent mixture and preferably benzyl alcohol such that the said the said final phenalkamine product has colour 1-2, amine value 290 mg/KOH and viscosity @ 25éC 500 cps.
